(19) United States
(12) Patent Application Publication
(10) Pub. No.: US 2004/0113099 A1
(43) Pub. Date: Jun. 17, 2004

(54) Gantry system for transport and delivery of a high energy ion beam in a heavy ion cancer therapy facility

(76) Inventors: Hartmut Eickhoff, Darmstadt (DE); Peter Spiller, Darmstadt (DE); Marius Pavlovic, Darmstadt (DE); Alexeiy Dolinskii, Darmstadt (DE); Walter Bourgeois, Darmstadt (DE)

Correspondence Address: Ronald R Santucci, Frommer Lawrence & Haug, 745 Fifth Avenue, New York, NY, 10151, US

(21) Appl. No.: 10/470,477

(22) PCT Filed: Feb. 6, 2002
(86) PCT No.: PCT/EP02/01222

(30) Foreign Application Priority Data
Feb. 6, 2001 (EP) 01 102 710.9
Feb. 6, 2001 (EP) 01 102 709.1
Feb. 6, 2001 (EP) 01 102 708.3

(51) Int. Cl. G21K 5/04

(52) U.S. Cl. 250/492.3

(57) ABSTRACT

The present invention relates to a gantry system for transport, delivery and treatment of a high energy ion beam in a heavy ion cancer therapy facility, which comprises two gantry quadrupole magnets (1, 2) positioned on an axis (17) of said gantry downstream of an takeover point of a high energy ion beam transport line and a first 45° bending dipole magnet (3) bending the ion beam away from the gantry axis positioned down stream of said quadrupole magnets (1, 2). Four additional quadrupole magnets (4, 5, 6, 7) are positioned downstream of the first bending magnet for defocusing and focusing the heavy ion beam. A second 45° bending dipole magnet (8) bends the ion beam parallel to the gantry axis (17) and two subsequent quadrupole magnets (9, 10) focus the ion beam toward a scanning system. A horizontal and a vertical scanning magnet (11, 12) positioned upstream a last 90° bending magnet (13) bending the ion beam away from the parallel to the gantry axis toward a perpendicular intersection with the axis at the ISO center scans the ion beam. A stack (14) of horizontal and vertical grids and of a scintillator monitors the profile and the position of the ion beam and of a horizontal and vertical veto counter monitors the position and of an ionization chamber monitors the intensity of the ion beam. Furthermore a positron emitter tomography camera (PET) is installed within a treatment area of the gantry.

The present invention relates to a gantry system for transport and delivery of a high energy ion beam in a heavy ion cancer therapy facility according to the subject matter of claim 1.

From U.S. Pat. No. 4,870,287 a gantry system for transport and delivery of a high energy proton beam in a cancer therapy facility is known. This system has the disadvantage that it cannot handle heavy ions like carbon ions, so that its efficiency is limited. Further it does not provide and can not handle a pencil like ion beam to treat a cancer tissue by said pencil like ion beam.

It is an object of the present invention to provide an improved gantry system for transport and delivery of a high energy ion beam in a heavy ion cancer therapy facility. Particularly it is an object of the present invention to provide appropriate electromagnetic optical components to direct a heavy ion beam toward an ISO center of a treatment station.

This object is achieved by the subject matter of independent claim 1. Features of preferred embodiments are defined in dependent claims.

According to the present invention a gantry system for transport, delivery and treatment of a high energy ion beam in a heavy ion cancer therapy facility comprises two gantry quadrupole magnets positioned on an axis of said gantry downstream of an takeover point of a high energy ion beam transport line and a first 45° bending dipole magnet bending the ion beam away from the gantry axis positioned down stream of said quadrupoles magnets. Four additional quadrupole magnets are positioned downstream of the first bending magnet for defocusing and focusing the heavy ion beam. A second 45° bending dipole magnet bends the ion beam parallel to the gantry axis and two subsequent quadrupole focus the ion beam toward a scanning system. A horizontal and a vertical scanning magnet positioned upstream a last 90° bending magnet bending the ion beam away from the direction parallel to the gantry axis toward a perpendicular intersection with the axis at the ISO center scans the ion beam. A stack of horizontal and vertical grids and of a scintillator monitor the profile and the position of the ion beam and of a horizontal and vertical veto counter monitors the position and of an ionization chamber monitors the intensity of the ion beam. Furthermore a positron emitter tomography camera (PET) is installed within a treatment area of the gantry.

This gantry system has the advantage that it provides a position and intensity controlled and monitored heavy ion beam toward the patient treatment couch and improves the precision of operating said ion beam by providing a scanned pencil like ion beam to treat the cancer tissue and improves the safety of the gantry system by a stack of in-situ diagnostic elements.

In a preferred embodiment the gantry system of the present invention comprises a barrel type 360° gantry. This has the advantage that any treatment angle of the ion beam relative to the patient couch is achievable without moving the patient couch.

In a further embodiment of the present invention-said gantry system comprises a pushing-wall construction. Such construction has the advantage that the pushing strength of the plates is superimposed to the flexural strength of the truss construction.

Preferably the gantry system comprises a central part at a wall thickness of at least 20 mm and a wheel thickness of at least 50 mm wherein the contact area covers at least 90° of two supporting wheels, which support the gantry system including said stack of monitoring grids as in-situ diagnostic elements.

The invention is now explained in details with reference to the attached drawings.

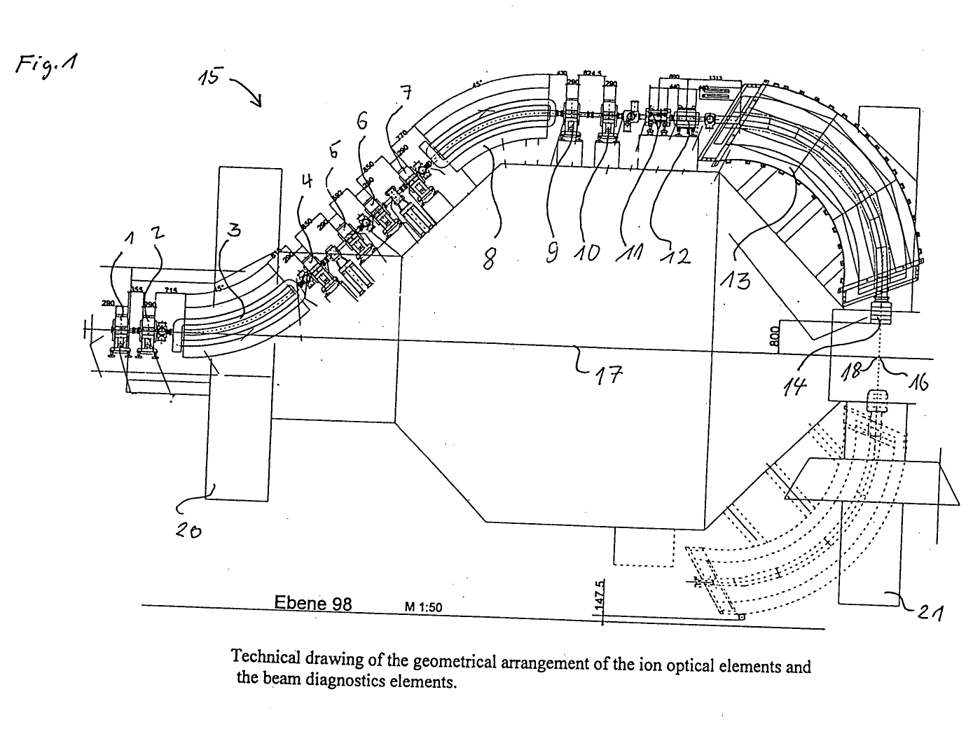

FIG. 1 shows a geometrical arrangement of the ion optical elements and beam diagnostic elements of the gantry system according to the present invention.

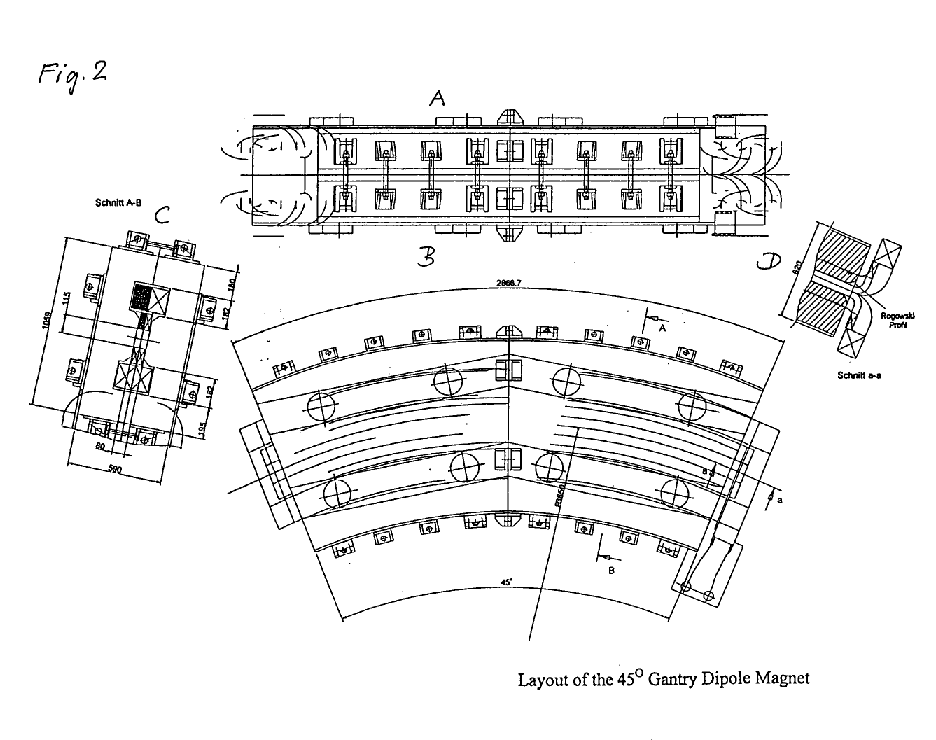

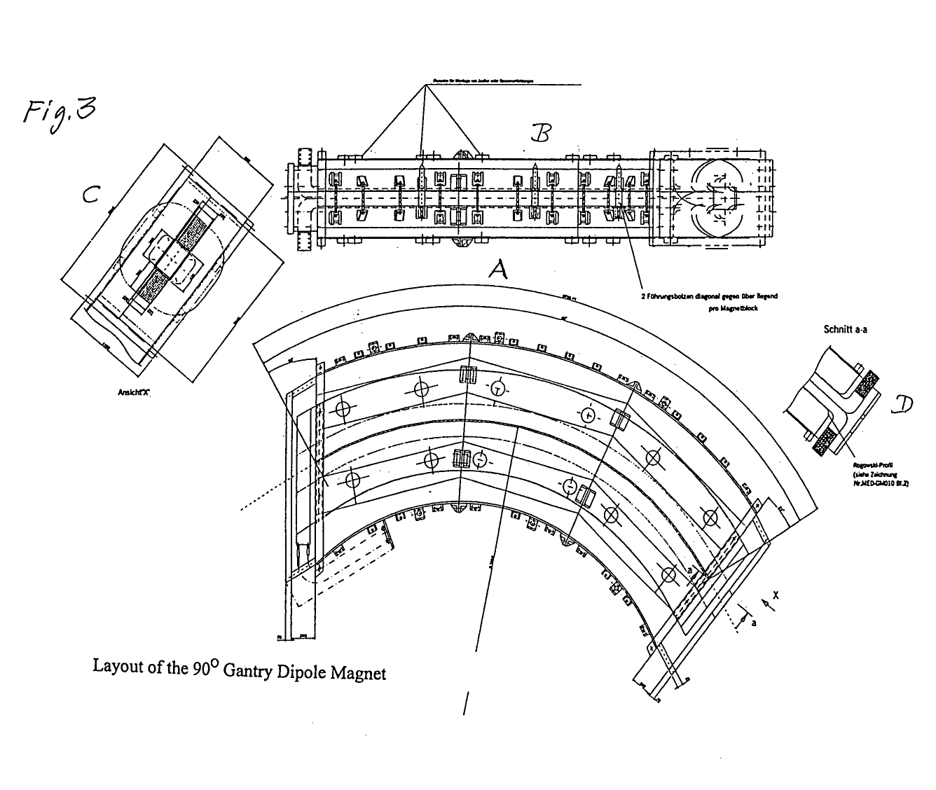

FIG. 2A to FIG. 2D show a layout of a 45° gantry dipole magnet.

FIG. 3A to FIG. 3D show a layout of a last 90° bending gantry dipole magnet.

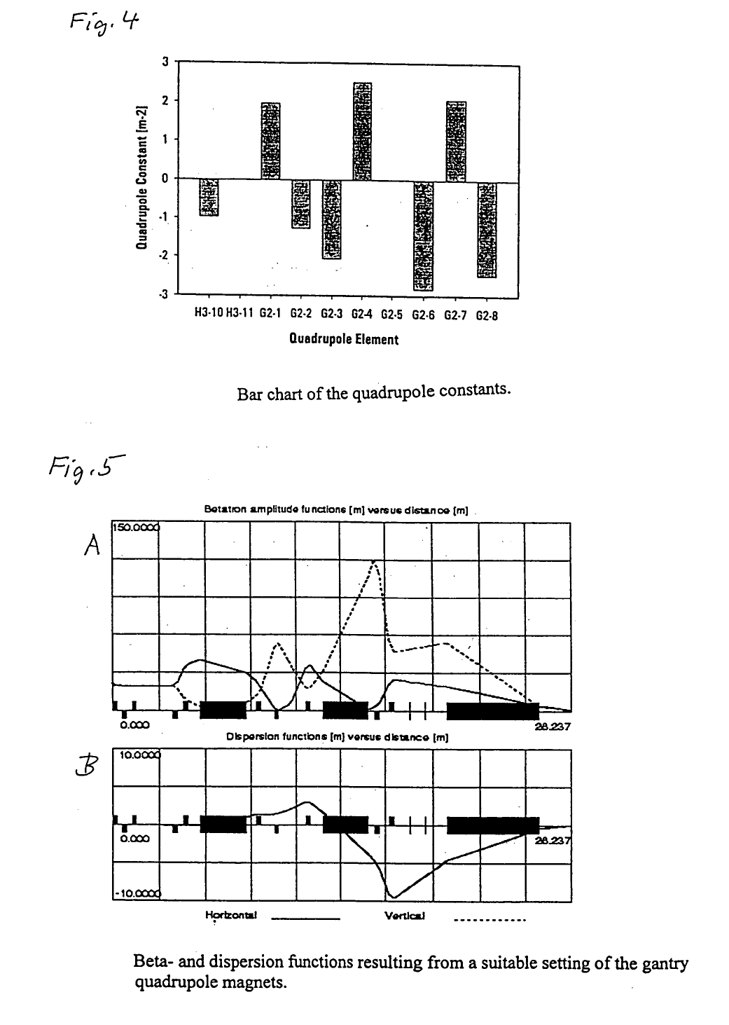

FIG. 4 shows a bar chart of quadrupole constants.

FIG. 5A and FIG. 5B show diagrams of beta- and dispersion functions.

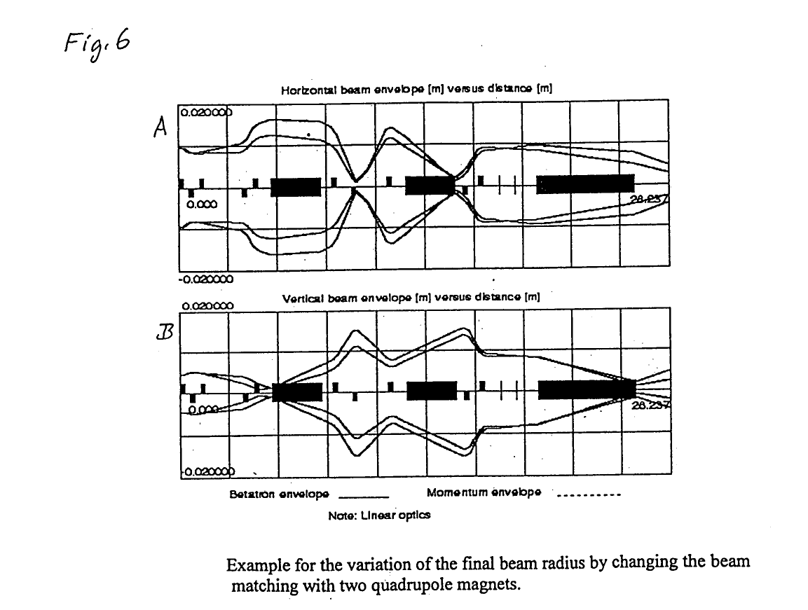

FIG. 6A and FIG. 6B show diagrams of an example for the variation of the final beam radius.

FIGS. 7A and 7B show diagrams of a gantry angle independent focusing.

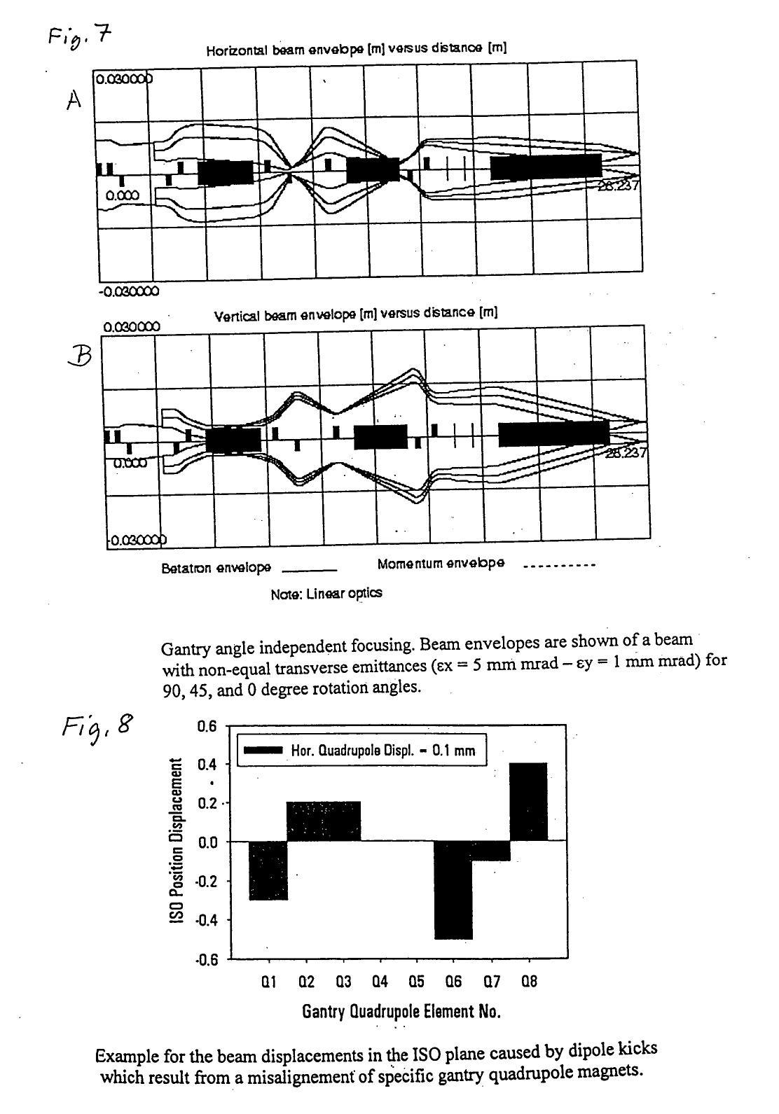

FIG. 8 shows a bar chart for an example for the beam displacement in the ISO plane.

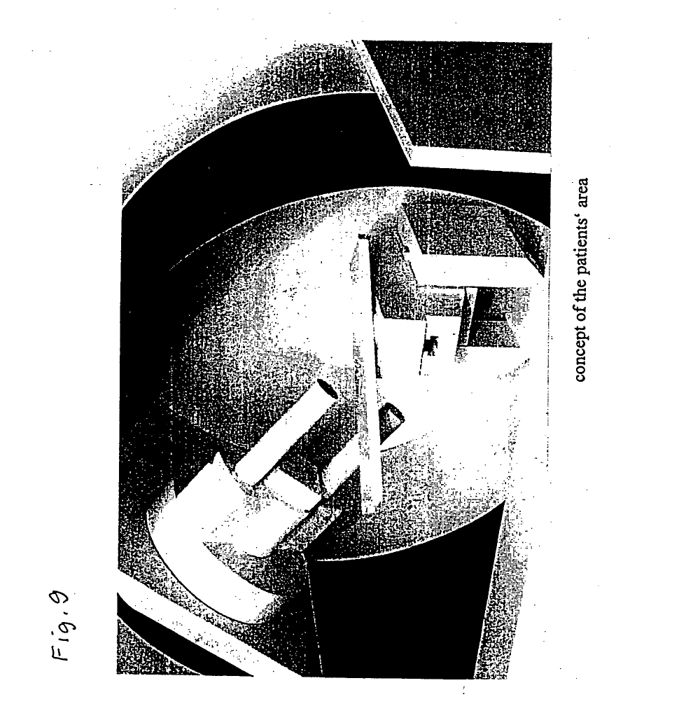

FIG. 9 shows a concept of the patient's area.

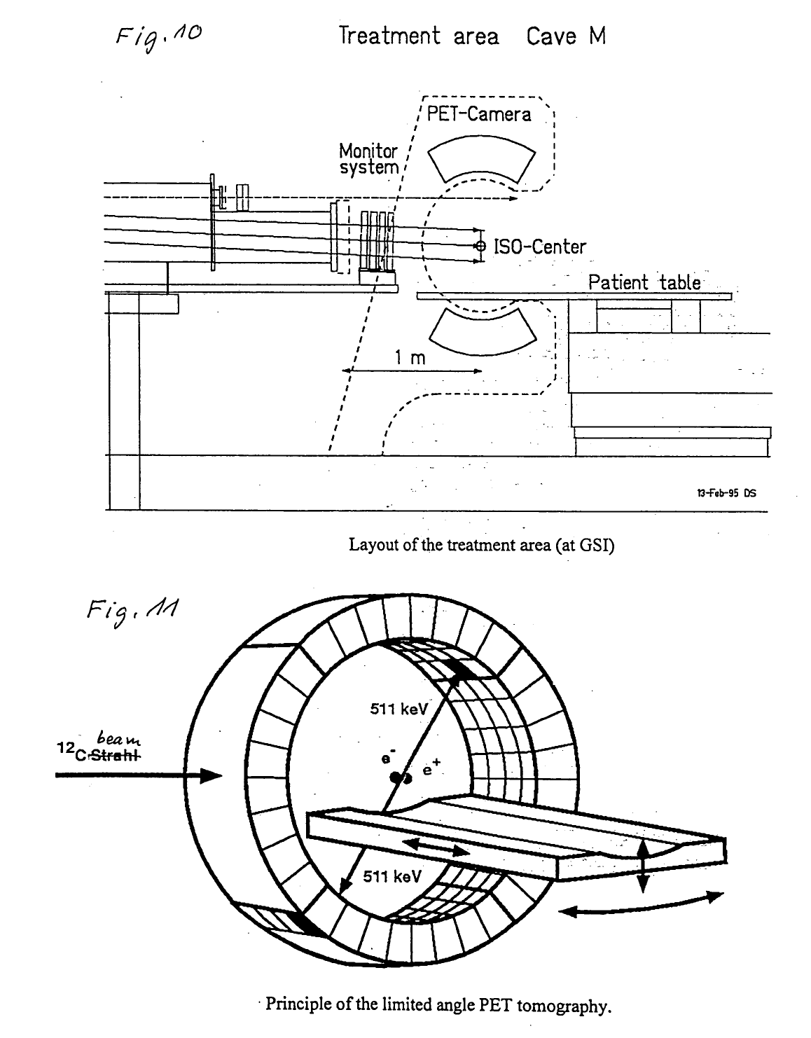

FIG. 10 shows a layout of the treatment area.

FIG. 11 shows a principle of the limited angle PET-topography.

FIG. 1 shows a geometrical arrangement of the ion optical elements and beam diagnostic elements of the gantry system 15 according to the present invention.

Reference signs 1 and 2 define gantry quadrupole magnets positioned on an axis 17 of said gantry system 15 downstream of a takeover point of a high energy ion beam transport line. Reference sign 3 defines a first 45° bending dipole magnet bending the ion beam away from the axis 17 and positioned downstream stream of said quadrupole magnets 1, 2. Reference signs 4, 5, 6 and 7 define additional quadrupole magnets positioned downstream of the first bending magnet 3 for defocusing and focusing the heavy ion beam. Reference sign 8 defines a second 45° bending dipole for bending the ion beam parallel to said gantry axis 17. Reference signs 9 and 10 define two subsequent quadrupole magnets focusing the ion beam toward a scanning system. Reference sign 11 defines a horizontal scanning dipole magnet and reference sign 12 defines a vertical scanning dipole magnet. Reference sign 13 defines a last 90° bending magnet bending the ion beam away from the parallel direction toward a perpendicular intersection 16 with said axis 17 at the ISO center 18 of said gantry system 15. Reference sign 14 defines a stack of grids and ionization chamber for profile and position monitoring of the ion beam in horizontal and vertical direction perpendicular to the beam axis 17 and for monitoring the beam intensity. Further the gantry system 15 comprises a positron emission tomography camera PET shown in FIG. 11 installed within a treatment area of the gantry system 15. The reference signs 20 and 21 define supporting wheels of the gantry system 15.

The gantry ion optical system shown in FIG. 1 provides the capability to treat patients from arbitrary directions perpendicular to the original horizontal beam axis. Since the magnetic rigidity of ion beams are comparably high one main design issue is to keep the overall dimension as small as possible. Therefore and in order to enable a parallel beam scanning, the raster scan system was placed upstream of the last 900 dipole magnet shown in FIG. 3. Thus, the gantry height is mainly defined by the distance of the ISO center from the 90° nozzle and the bending radius of the 90° dipole magnet. By using rather large bending angles and high flux densities in the first and second dipole magnet, the horizontal dimension can be kept relatively small, too.

The gantry ion optical system has the capability for beam focusing down to spot radii between 2 to 5 mm measured in the ISO-plane. This range of spot radii is achievable at all rigidity levels and at all expected transverse emittance aspect ratios up to 1:5. Furthermore, the focusing properties are independent from the gantry rotation angle. This can be achieved by an appropriate set of initial beam parameters and an adequate setting of the gantry quadrupole magnets.

In general the final beam radius is determined by the final beta function β and the beam emittance ε:R=√(β·ε).

The final β-function can be calculated by transferring the twiss parameters from the entrance of the gantry to the ISO-plane βf=(X,X)²βi−2(X,X) (X,X′)αi+(X,X′)²γi.

Two options may be considered for a rotation angle independent focusing:

1. The so called magnification terms (X,X) and (Y,Y) of the gantry system are zero or at least minimized. Thus the final beam radius does not depend significantly on the initial twiss parameters β and α. The final beam radius, which is in this case only given by the dependence of the initial twiss parameter γ, is constant for different rotation angles, if the beam divergence √(γx·εx) and √(γy·εy) are equal at the take over point and (X,X′) and (Y,Y′) are equal.

2. The dependence of the system on the initial angles (X,X′) and (Y,Y′) are zero or at least minimized. Thus the final beam radius does not depend significantly on the initial beam angels. The final beam radius which is in this case only given by the magnification term (X,X), is constant for different rotation angles, if the beam radii √(βx·εx) and √(βy·εy) are equal at the take over point and the magnification terms (X,X) and (Y,Y) are equal.

The most suitable case and most natural case for the gantry optical system is the first option, where the matrix elements (X,X) and (Y,Y) are zero. In a realistic gantry design typical values of less than 10-3 can be achieved.

The terms (X,X′) and (Y,Y′) are typically about 1-10 (about 1000 times larger than (X,X) and (Y,Y)) and can be fitted to be equal.

Varying beam radii in the ISO plane due to different transverse beam emittances must be compensated by the matching system in front of the gantry. At non-equal horizontal and vertical emittances the final beam can be kept circular at rotation when γx·εx=γy·εy can be realized at the gantry entrance.

At resonance extraction mainly the vertical beam emittance is damped according to the final energy. Thus, the aspect ratio of the transverse emittances will vary according to the beam energy. Furthermore the final beam radius is independent from the beam momentum spread. Thus the gantry optics are achromatic. This means that the dispersion function at the entrance of the gantry and the dispersion in the ISO plane are zero.

The vanishing dispersion Dx and the derivative of the dispersion dDx/dz at the gantry entrance and the matching system are generated by the beam delivery system upstream the matching system.

An adequate angle independent gantry optics has the following boundary conditions:

a) (X,X)=(Y,Y)=0

b) (X,X′)=(Y,Y′)

c) (X,P)=0

d) Rx=Ry=Goal value

These conditions are fulfilled in the present invention with restricted magnet apertures. This means that the beam radius shouldn't exceed the acceptance of the system when the emittance aspect ratio is being large and the gantry is being rotated.

TABLE 1
Set of quadrupole constants fulfilling the described
criteria

| Quadrupole | Quadrupole Constant |
|---|---|
| Element | [m⁻²] |
| B3-QD11 | −0.9704 |
| B3-QS12 | 0.00235 |
| G2-QD11 | 1.958 |
| G2-QD12 | −1.2735 |
| G2-QD21 | −2.059 |
| G2-QD22 | 2.505 |
| G2-QD31 | 0 |
| G2-QD32 | −2.835 |
| G2-QD41 | 2.067 |
| G2-QD42 | −2.477 |

The advantage of a gantry shown in FIG. 1 is that it enables an ion beam treatment of large volume tumours at almost arbitrary locations in the patient body. Combined with a suitable treatment couch shown in FIG. 11 a barrel-type 360° gantry offers maximum flexibility for the treatment planning and accessibility from almost all directions.

### Ion Optical Elements

The zero degree gantry angle in the following descriptions of ion optical and technical properties is defined as the rotation angle where the bending direction of the main gantry dipole magnets is horizontally.

TABLE 2
Physical (optical) parameters

| | | Length | Horizontal | Vertical | Max.Flux | Field |
|---|---|---|---|---|---|---|
| Main ion optical | | of optical axis | Aperture | Aperture | Density | Homogeneity |
| Components | No. | [m] | [m] | [m] | [T] | [T] |
| 45° dipole magnets | 2 | 2.866 | 0.08 | 0.07 | 1.81 | 5 · 10⁻⁴ |
| 90° dipole magnets | 1 | 5.732 | 0.23 | 0.23 | 1.81 | 2 · 10⁻⁴ |
| Quadrupole | 8 | 0.29 | 0.085 | 0.085 | 0.8 | 3 · 10⁻³ |
| magnets | | | | | | |
| Hor. steerer | 3 | 0.2 | 0.07 | 0.07 | 0.3 | |
| Vert. steerer | 3 | 0.2 | 0.07 | 0.07 | 0.3 | |
| Hor. raster scanner | 1 | 0.44 | 0.14 | 0.13 | 0.38 | |
| Vert. raster scanner | 1 | 0.44 | 0.13 | 0.14 | 0.38 | |

TABLE 3
Technical parameters

| | | Maximum | Maximum | Maximum | Cooling | |
|---|---|---|---|---|---|---|
| Main ion optical | | Voltage | Current | Power | water | Total weight |
| components | No. | [V] | [A] | [kW] | [l/min] | [t] |
| 45° dipole magnets | 2 | 294 | 650 | 86 | 41 | 13 |
| 90° dipole magnets | 1 | 596 | 2144 | 660 | 633 | 69 |
| Quadrupole | 8 | 49 | 181 | 8 | 3.85 | 0.71 |
| magnets | | | | | | |
| Hor. stecrer | 3 | | | | | |
| Vert. steerer | 3 | | | | | |
| Hor. raster scanner | 1 | +−390 | +−540 | 11.6 | 7.6 | 0.273 |
| Vert. raster scanner | 1 | +−390 | +−540 | 11.6 | 7.6 | 0.273 |

TABLE 4

| Beam Diagnostic Components | No. |
|---|---|
| Wire grids for profile and position monitoring | 5 |
| (hor./vert) | |
| Veto counter for position monitoring (hor./vert.) | 1 |
| Ionization chamber for intensity monitoring | 1 |

For generating the required beam radii in the ISO center the following quadrupole settings may be used (assumed is a transverse emittance of 5×5 mm mrad):

TABLE 5

| | | Quad. | |
|---|---|---|---|
| | | Constants | Quad. |
| R | β | B3/4-QD11 | Constants |
| [mm] | [m] | [m²] | B3/4-QD12 [m²] |
| 2 | 1 | −0.98 | 0 |
| 3 | 2.25 | −1.09 | 0.254 |
| 4 | 4 | −0.971 | 0.253 |
| 5 | 6.25 | −0.903 | 0.285 |

According to the specific setting, a displacement of the quadrupole elements will cause a dipole kick. The expected horizontal dipole kicks of misaligned quadrupole magnets are listed in the following table under the assumption of a lateral displacement of 0.1 mm:

TABLE 6

| Gantry | Kick |
|---|---|
| Quadrupole | [mrad] |
| Q1 | −0.028 |
| Q2 | 0.021 |
| Q3 | 0.032 |
| Q4 | −0.033 |
| Q5 | 0.001 |
| Q6 | 0.037 |
| Q7 | −0.032 |
| Q8 | 0.038 |

The kick angles scale linear with the quadrupole displacement and the quadrupole gradient. Therefore, the magnitude of the individual kick angles depend on the specific setting of the gantry quadrupole magnets. As a consequence of the dipole kicks the beam experience a displacement in the ISO plane. The calculated beam position displacements resulting from the kicks.

As the example indicates, a relevant beam displacement (≈0.5 mm) in the ISO center can be expected starting from a misalignment of 0.1 mm. This displacement of the beam position is corrected by the help of steerer magnets. Furthermore, an angle dependent deformation of the optical axis can be expected during the gantry rotation. Any effort to keep this deformation sufficiently small (<0.2 mm) by a substantial enhancement of the wall thicknesses leads to a major increase in gantry weight. Therefore, a compromise between sufficient mechanical stiffness of the gantry structure and possible corrections of the beam position by steerer magnets is found in the present invention.

The mechanical design of the gantry structure as shown in FIG. 1 is optimized with respect to the position stability of the ion optical elements at arbitrary gantry angles. Three different concepts are investigated.

A high stability may be achieved in a pushing-wall construction. Such a construction has the advantage that the pushing strength of the plates is superimposed to the flexural strength of the truss construction. A most realistic estimate of the maximum deformation can be obtained by a finite element analyses. For this purpose a three dimensional model is generated including a realistic modeling of the effects of the contact area. The total weight of the overall structure is calculated to be 675 t at a wall thickness of 20 mm for the central part and a thickness of 50 mm for the two supporting wheels. The contact area covers 90 degree of the wheels.

The calculations show that the maximum deformations could not be improved significantly by choosing thicker walls. The maximum deviations of −0.84 mm were detected at a gantry angle of 90°.

FIG. 2A to FIG. 2D are self explaining and show different views of a layout of the 45° gantry dipole magnet.

FIG. 3A to FIG. 3D are self explaining and show different views of a layout of the 90° gantry dipole magnet.

FIG. 4 is self explaining and shows a bar chart of quadrupole constants.

FIG. 5A and FIG. 5B are self explaining and show Beta- and dispersion functions resulting from a suitable setting of the gantry quadrupole magnets.

FIG. 6A and FIG. 6B show an example for the variation of the final beam radius b y changing the beam matching with two quadrupole magnets.

FIG. 7A and FIG. 7B show a gantry angle independent focusing by beam envelopes of a beam with non-equal transverse emittances for 90, 45, and 0 degree rotation angles.

FIG. 8 shows an example for a beam displacement in the ISO-plane caused by dipole kicks which result from a misalignment of specific gantry quadrupole magnets. The structural bearing of the gantry is proposed to be rigid. The overall deformation of the Gantry during one turn of 360 degree is limited to 0.5 mm to stabilize the ISO-center. Furthermore a turn angle dependent position correcting means is provided to compensate this deformation.

FIG. 9 shows a concept of the patient's area. The treatment room is assumed to be mounted towards the main building construction. One possibility is to fix the patient's area on to one of the main building walls and another possibility is to mount the patient's area on to a structural bearing of the gantry. Therefore, any movement of the mechanical gantry does not lead to a movement of the patient position.

The wheel supports are dimensioned according to a weight distribution of 460 t on the front wheel and the 216 t on the back wheel. The number of rolls for the front wheel is 12 with a maximum force in the main bearing of 254 MN. The number of rolls for the back wheel is 6 with a maximum force of 1.1 MN in the main bearing. The length of the carrying lines of the rolls is for the front wheel 473 mm and the back wheel 438 mm.

All supports of the optical elements are equipped with screws for an adjustment in all three spatial directions. The supports are arranged on both sides of each elements in equal height with the optical axis. Thus, temperature can be minimized.

The displacement of the ion optical elements caused by temperature variations of the gantry structure were estimated.

Since the treatment room does not move with the gantry, temperature prolongations causes a movement of the ISO center with respect to the patient position and temperature effects lead to a displacement of the optical elements and therefore to a displacement of the beam position with respect to the ISO center. To minimize this effect at the patient position one bearing at the beam entry of the gantry is an radial bearing without any axial bearing component. The maximum calculated prolongation is 0.187 mm/°C.

In order to avoid local temperature variations the air in the gantry room is recirculated and local heat sources may be equipped with fan.

The gantry is rotated by a NC-electrical engine is equipped with three measuring systems. The twisting moment is transmitted by a chain to the gantry.

Non-plane magnet configuration, as in the gantry, can be adjusted by a laser tracker system.

FIG. 10 is self explaining and shows a layout of the treatment area.

Four treatment areas are provided: two with a fixed horizontal beam line (B1, QS) and two at the exit of isocentric gantries.

As for all treatment areas the intensity controlled raster-scanning procedure will be used.

Due to the fact that the ions undergo nuclear reactions in the tissue traversed proximal to the treatment volume a reasonable amount of positron emitting nuclei is generated. These positron emitting nuclei have similar ranges compared to the incident projectiles. Some of these isotopes comprise halflife periods of some seconds which offers the possibility of monitoring the gamma radiation of the annihilation processes. By this method the range distribution of the delivered particles can be monitored without applying an additional dose to the patient.

FIG. 11 shows a principle of a limited angle PET-camera. In FIG. 11 the patient couch is surrounded by a sketched ring that contains detector crystals capable of recording the gamma quanta from the annihilation events. Here it is impossible to use a fully equipped ring in order to guarantee sufficient degrees of freedom for the patient positioning system. Consequently, this technique is called limited angle tomography.

TABLE 7

| type | | Dipole (H-type) |
|---|---|---|
| bending angle | [°] | 45 |
| curvature-radius | [m] | 3.65 |
| pathlength | [m] | 2.867 |
| yoke length | [m] | 2.848 |
| yoke height | [m] | 0.59 |
| yoke width | [m] | 1.035 |
| thickness of laminates | [mm] | 1 |
| maximum flux density | [T] | 1.81 |
| field homogeneity δ = ΔB/B | | ±2.5 * 10⁻⁴ |
| edge-angle | [°] | 22.5° ? |
| number of yoke-segments | | 2 |
| area of field-hom. δ (height, width) | [mm²] | 80 * 80 |
| geom. gap height | [mm] | 80 |
| geom. gap width | [mm] | 115 |
| total number of windings | | 188 (140 + 48) |
| maximum coil current Iₘₐₓ | [A] | 650 |
| current accuracy δI/Iₘₐₓ | | <1 * 10⁻⁴ |
| max. DC-voltage | [V] | 132 |
| total coil resistance | [mΩ] | 204 |
| inductance | [mH] | 498 |
| maximum DC-power consumption | [kW] | 86 |
| ramping rate | [T/s] | 0.33 |
| maximum total voltage | [V] | 294 |
| number of cooling channels | | 15 |
| total cooling water supply | [l/min] | 41.3 |
| total weight | [to] | 12.86 |

Parameters of the 45° Gantry Dipole Magnet

TABLE 8

| type | | quadrupole |
|---|---|---|
| max. gradient B′ | [T/m] | 18.8 |
| max. quadrupole constant (B′/Bρ) | [m⁻²] | 2.8 |
| max. pole flux density | [T] | 0.8 |
| max. yoke flux density | [T] | 1.9 |
| effective length | [m] | 0.519 |
| B′*effectve length | [T] | 6.0 |
| yoke length | [m] | 0.29 |
| yoke height | [m] | 0.743 |
| yoke width | [m] | 0.743 |
| thickness of laminates | [mm] | 1.0 |
| field homogeneity δ = ΔB′/B′ | | ±1.5 * 10⁻³ |
| number of yoke-segments | | 1 |
| area of field-hom. δ (diameter) | [mm] | 80 |
| geom. aperture diameter | [mm] | 85 |
| number of windings/pole | | 82 |
| maximum coil current Iₘₐₓ | [A] | 181 |
| current accuracy δI/Iₘₐₓ | | <1 * 10⁻³ |
| max. DC-voltage | [V] | 44.3 |
| total coil resistance | [mΩ] | 244 |
| inductance | [mH] | 123 |
| maximum DC-power consumption | [kW] | 8.0 |
| ramping rate | [A/s] | 181 |
| maximum total voltage | [V] | 66.7 |
| number of cooling channels | | 8 |
| total cooling water supply | [l/min] | 3.9 |
| total weight | [to] | 0.71 |

Parameters of the Quadrupole Magnet (Gantry)

TABLE 9

| type | | Dipole (WF-type) |
|---|---|---|
| bending angle | [°] | 90 |
| curvature-radius | [m] | 3.65 |
| pathlength | [m] | 5.733 |
| yoke length | [m] | 5.162 |
| yoke height | [m] | 0.9 |
| yoke width | [m] | 1.846 |
| thickness of laminates | [mm] | 1 |
| maximum flux density | [T] | 1.81 |
| field homogeneity δ = ΔB/B | | ±1 * 10⁻⁴ |
| edge-angle | [°] | 30° (entrance); 21° (exit) |
| number of yoke-segments | | 3 |
| area of field-hom. δ (height, width) | [mm²] | 200 * 200 |
| geom. gap height | [mm] | 230 |
| geom. gap width | [mm] | 380 |
| total number of windings | | 170 |
| maximum coil current Iₘₐₓ | [A] | 2143 |
| current accuracy δI/Iₘₐₓ | | <1 * 10⁻⁵ |
| max. DC-voltage | [V] | 310 |
| total coil resistance | [mΩ] | 144 |
| inductance | [mH] | 609 |
| maximum DC-power consumption | [kW] | 660 |
| ramping rate | [T/s] | 0.4 |
| maximum total voltage | [V] | 600 |
| number of cooling channels | | 34 |
| total cooling water supply | [l/min] | 633 |
| total weight | [to] | 68.6 |

Parameters of the 90° Gantry Dipole Magnet

TABLE 10
Vacuum chamber for the 90° Gantry Dipole Magnet

| shape | | rectangular (90° curved) |
|---|---|---|
| thickness | [mm] | 6 |
| outer hight | [mm] | 228 |
| outer width | [mm] | 236 |

1. A gantry system for transport, delivery and treatment of a high energy ion beam in a heavy ion cancer therapy facility comprising:
two gantry quadrupole magnets (1, 2) positioned on an axis of said gantry downstream of an takeover point of a high energy ion beam transport line;
a first 45° bending dipole magnet (3) bending the ion beam away from the gantry axis (17) positioned down stream of said quadrupole magnets (1, 2);
four additional quadrupole magnets (4, 5, 6, 7) positioned downstream of the first bending magnet (3) for defocusing and focusing the heavy ion beam;
a second 45° bending dipole magnet (8) bending the ion beam parallel to the gantry axis (17);
two subsequent quadrupole magnets (9, 10) focusing the ion beam toward a scanning system;
a horizontal and a vertical scanning magnet (11, 12) positioned upstream a last 90° bending magnet (13) bending the ion beam away from the parallel to the gantry axis (17) toward a perpendicular intersection (16) with the axis (17) at the ISO center (18);
a stack (14) of horizontal and vertical grids for profile and position monitoring and of a scintillator for profile and position monitoring and of a horizontal and vertical veto counter for position monitoring and of an ionization chamber for intensity monitoring; and
a positron emitter tomography camera (PET) installed within a treatment area of the gantry.

2. The gantry system according to claim 1, characterized in that said gantry system (15) comprises a barrel type 360° gantry.

3. The gantry system according to claim 1 or claim 2, characterized in that said gantry system (15) comprises a pushing-wall construction

4. The gantry system according to one of the previous claims, characterized in that said gantry system (15) comprises a central part at a wall-thickness of at least 20 mm and a wheel thickness of at least 50 mm, wherein the contact area covers at least 90° of the wheels (20, 21).
